(19) United States
(12) Patent Application Publication
(10) Pub. No.: US 2024/0078900 A1
(43) Pub. Date: Mar. 7, 2024

(54) SYSTEM AND METHOD FOR SIMULATING A MULTIMODAL TRANSPORTATION NETWORK

(71) Applicant: HYPERLOOP TECHNOLOGIES, INC., Los Angeles, CA (US)

(72) Inventors: Jerome Hubert WEI, La Habra, CA (US); Leo Waiho WONG, Walnut, CA (US); Walter WANG, Hacienda Heights, CA (US)

(21) Appl. No.: 18/260,218

(22) PCT Filed: Nov. 23, 2021
(86) PCT No.: PCT/US2021/060476

§ 371 Date: Jun. 30, 2023

Related U.S. Application Data
(60) Provisional application No. 63/134,191, filed on Jan. 6, 2021.

(51) Int. Cl. G08G 1/01; G06N 7/01

(52) U.S. Cl. CPC G08G 1/0129; G06N 7/01

(57) ABSTRACT

A system and method for simulating a transportation network is disclosed herein. A simulation may be configured at a configuration application, which enables designers and hyperloop operators to enter real-world constraints as alignment data. A plurality of travel scenarios may be run in order to generate simulated run results. An analytics engine may perform analysis on the simulated run results in order to inform designers and hyperloop operators seeking to improve the transportation network. A prediction modeler may be utilized to predict events occurring in the transportation network as simulated. Parallel processing may be utilized to increase the efficiency and speed of the simulation. The simulation may be performed before, during, and after the implementation of the transportation network.

### CROSS REFERENCE AND PRIORITY TO RELATED APPLICATIONS

This application claims the benefit of priority to U.S. Provisional No. 63/134,191 entitled “System and Method for Simulating a Multimodal Transportation Network,” filed on Jan. 6, 2021. All the aforementioned applications are hereby incorporated by reference in their entirety.

### BACKGROUND

Managing a modern shipping port is a complex problem. As real estate at port locations becomes scarcer, shipping companies are looking for ways to increase capacity while not increasing real-estate-related costs. Land adjacent to port locations is generally more expensive than inland areas offering similar access, space, functionality, etc. However, hyperloop may address many of the issues facing modern ports across the world.

Hyperloop is a passenger and cargo transportation system relying on a sealed tube and a bogie attached to a pod. The sealed tube may have a substantially lower air pressure than the external environment. As such, the bogie and the attached pod may travel with reduced air resistance, thus increasing energy efficiency as well as performance. Further, the acceleration and the velocity of the bogie may be substantially higher than a comparable bogie operating within a gas environment with a higher pressure. Some hyperloop systems rely on magnetic levitation (sometimes referred to as “maglev”). The advantage of using maglev is a further reduction in friction viz. the resistance between a traditional wheel and a traditional track is eliminated by using a maglev-based bogie. Hyperloop is in the early stages of development and commercialization. However, the projected velocity of the bogie may exceed 700 mph (1,127 km/h) in commercialized implementations.

Given the capabilities of hyperloop to move cargo (and passengers), a solution may be available to address the challenges of shipping near ports and even airports. What is needed is a system and method for simulating a hyperloop-based transportation network serving ports and airports.

### SUMMARY

A method is disclosed for simulating a transportation network and may be based on configuring, at a configuration application running on a processor, alignment data, wherein the alignment data relates to real-world constraints of the transportation network. The method may store, at a configuration database running on the processor, the alignment data. The method may further define, at the configuration application running on the processor, a plurality of travel scenarios, wherein the plurality of travel scenarios relates to movement of vehicles in the transportation network. The method may then store, at the configuration database, the plurality of travel scenarios.

The method may further simulate, at a data integration module running on the processor, a simulated run of a plurality of vehicles, wherein the simulating is performed based on the plurality of travel scenarios and the alignment data. The method may further store, at the data integration module running on the processor, a plurality of simulated run results. The method may generate, at an analytics engine running on the processor, a plurality of analytics, wherein the plurality of analytics is based on the plurality of simulated run results. The method may further output, at the configuration application, report data, wherein the report data comprises the plurality of simulated run results and the plurality of analytics.

The method may select a plurality of vehicles from the group consisting of: a hyperloop pod and a terminal vehicle. The alignment data may further comprise velocity profile data, portal model data, demand model data, cost model data, and vehicle model data. The simulated run may be executed using parallel execution. The configuration application may be a desktop application, a mobile application, a cloud-based application, or a combination thereof.

The method may further predict, at a prediction modeler running on the processor, an event occurring within the transportation network, wherein the predicting is performed based on the plurality of simulated run results. The simulated run is performed on a batch of travel scenarios selected from the plurality of travel scenarios.

The batch of travel scenarios may be generated using a Monte Carlo algorithm. The report data may further comprise a batch report, wherein the batch report is based on the batch of travel scenarios.

A server is disclosed and may be configured to simulate a transportation network. The server may comprise a memory and a processor. The memory may store a configuration database, a configuration application, an analytics engine, a prediction modeler, and a data integration module. The processor may be configured to configure, at the configuration application, alignment data, wherein the alignment data relates to real-world constraints of the transportation network.

The processor may further store, at the configuration database, the alignment data and define defining, at the configuration application, a plurality of travel scenarios, wherein the plurality of travel scenarios relates to movement of vehicles in the transportation network. The processor may store, at the configuration database, the plurality of travel scenarios. The processor may further simulate, at a data integration module, a simulated run of a plurality of vehicles, wherein the simulating is performed based on the plurality of travel scenarios and the alignment data.

The processor may further store, at a data integration module, a plurality of simulated run results and generate, at the analytics engine, a plurality of analytics, wherein the plurality of analytics is based on the plurality of simulated run results. The processor may further output, at the configuration application, report data, wherein the report data comprises the plurality of simulated run results and the plurality of analytics.

The plurality of vehicles may be selected from the group consisting of: a hyperloop pod and a terminal vehicle. The alignment data may further comprise velocity profile data, portal model data, demand model data, cost model data, and vehicle model data. The simulated run may be executed using parallel processing. The processor may further be configured to predict, at the prediction modeler, an event occurring within the transportation network, wherein the predicting is performed based on the plurality of simulated run results. The simulated run may be performed on a batch of travel scenarios selected from the plurality of travel scenarios. The configuration application may be a desktop application, a mobile application, a cloud-based application, or a combination thereof.

The batch of travel scenarios may be generated using a Monte Carlo algorithm. The report data further comprises a batch report, the batch report being based on the batch of travel scenarios.

A computer-readable medium is disclosed that may store instructions that, when executed by a computer, cause the computer to configure, at a configuration application running on a processor, alignment data, wherein the alignment data relates to real-world constraints of the transportation network. The computer-readable medium may further store, at a configuration database running on the processor, the alignment data.

The computer-readable medium may further define, at the configuration application, a plurality of travel scenarios, wherein the plurality of travel scenarios relates to movement of vehicles in the transportation network. The computer-readable medium may further store, at the configuration database, the plurality of travel scenarios. The computer-readable medium may further simulate, at a data integration module running on the processor, a simulated run of a plurality of vehicles, wherein the simulating is performed based on the plurality of travel scenarios and the alignment data. The computer-readable medium may further store, at the data integration module, a plurality of simulated run results. The computer-readable medium may further generate, at an analytics engine running on the processor, a plurality of analytics, wherein the plurality of analytics is based on the plurality of simulated run results. The computer-readable medium may further output, at the configuration application, report data, wherein the report data comprising the plurality of simulated run results and the plurality of analytics. The computer-readable medium may be configured to predict, at the prediction modeler, an event occurring within the transportation network, wherein the predicting is performed based on the plurality of simulated run results.

### BRIEF DESCRIPTION OF DRAWINGS

The accompanying drawings, which are incorporated herein and constitute part of this specification, illustrate exemplary aspects of the claims, and together with the general description given above and the detailed description given below, serve to explain the features of the claims.

FIG. 1 is a block diagram illustrating a transportation network.

FIG. 2 is a block diagram illustrating a simulation system.

FIG. 3 is a flow diagram illustrating a process for simulating a transportation network.

FIG. 4 is a block diagram illustrating an example computing device suitable for use with the various aspects described herein.

FIG. 5 is a block diagram illustrating an example server suitable for use with the various aspects described herein.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Ports rely on having a certain amount of physical space to accommodate shipping containers. Often, shipping containers are offloaded into stacks throughout the port. Like any finite resource, the land area may be quickly consumed when demand is high. As such, ships may be required to wait for hours or even days while the port is cleared such that containers may be unloaded. One of skill in the art will appreciate that ships are more profitable when fully loaded. Therefore, the ships must often wait for not only unloading but also for loading operations which may likewise be delayed. In short, delays at port locations may be directly attributed to the lack of cargo space at the port itself, not necessarily in the cargo ship. The same is true for airports.

The disclosed solution provides a system and method for generating and executing simulations related to cargo transfer between a port (or airport) and a final destination. The actual port may then be upgraded to support hyperloop operations. The disclosed solution is configured to simulate the logistical considerations as well.

Port operations largely involve moving containers to terminal vehicles, such as trucks configured to carry shipping containers. When a ship reaches the berth, a crane removes the containers from the ship and places the containers in stacks throughout the port. Terminal vehicles are constrained by the limited area of the port such that the containers are delayed while being loaded onto terminal vehicles. Further, the process of stacking containers is inefficient compared with directly loading the containers into vehicles. However, directly loading shipping containers into terminal vehicles is not always an option.

The disclosed, hyperloop-based solution may address some of the issues related to transferring the container from the ship to the terminal vehicle such that the contained goods may reach a final destination more efficiently. The disclosed solution provides a system and method for simulating the terminal vehicle interactions with both the ships (or aircraft) and the port (or airport) equipment used to transfer cargo. However, scheduling a hyperloop-based system requires advanced simulation systems as the one proposed herein. Further, simulation enables designers and engineers to both test and adjust proposed and operating hyperloop network designs.

The nature of transportation is complex and requires the coordination of many related systems. Traditionally, transportation networks are configured largely by human designers who are performing the work by hand. However, hyperloop is far more complex and revolutionary than any existing mode of transportation. A number of factors create this complexity viz. high velocities, controlled-pressure environments, maglev interactions, new infrastructure requirements, tight scheduling requirements, etc. Human designers lack the tools and systems to adequately test and simulate a proposed hyperloop network because existing tools are simply inadequate for the task.

The disclosed solution provides designers of a hyperloop network with the tools and systems to not only test and simulate the hyperloop network but also to adjust the hyperloop network based on feedback received from the disclosed solution. One feature of the disclosed solution is the capability to generate batches of scenarios and test the scenarios using parallel execution in order to simulate (and even validate) a myriad of travel scenarios in a short amount of time. A benefit of such simulation is a reduced time to market for operators of hyperloop networks, who are seeking a return on capital sooner rather than later.

The term of art “passengers and passes” or “PAX” essentially refers to a unit of cargo and/or passengers being transported in a transportation system. In terms of hyperloop, PAX correlates to fares. Unlike traditional fares that are simply based on a single mode of travel, hyperloop may have multimodal transportation. For example, a travel scenario may be as follows: a hyperloop vehicle picks up cargo, the hyperloop vehicle delivers the cargo to a port, a crane lifts the cargo into a ship, the ship then carries the cargo to a second port, a second crane offloads the cargo, a second hyperloop vehicle picks up the cargo, and finally the cargo is delivered by the hyperloop vehicle to a destination. Such a travel scenario is a simple example and does not account for the interactions of other hyperloop vehicles and terminal vehicles having a unique (and potentially conflicting) travel scenario. In short, designers require a tool and system to address the complex (and sometimes multimodal) nature of hyperloop travel that requires various travel scenarios to be simulated, tested, and validated.

The disclosed solution provides a system and method for designers to craft travel scenarios that may be used to simulate, test, and validate a transportation network. Travel scenarios may be generated by conceivably any stakeholder in the transportation network. For instance, a hyperloop infrastructure company may generate travel scenarios to test stress loads on a segment of superstructure. Whereas, a hyperloop operator may generate travel scenarios to simulate and evaluate fares for PAX. The disclosed solution provides for generating custom travel scenarios for testing and simulation.

Human designers have both mental and temporal limitations when crafting travel scenarios. As stated, travel scenarios may be manifold and complex. However, a human designer may only be able to create so many travel scenarios in order to simulate a hyperloop network. Designers simply cannot create enough travel scenarios to properly simulate and test a hyperloop network either being deployed or already in operation. Without adequate travel scenario coverage, the resulting hyperloop network may have flaws that lead to safety issues, inefficient operation, increased costs, etc.

The disclosed solution provides a system and method to generate multiple travel scenarios using a Monte Carlo algorithm. As such, the generated travel scenarios have more coverage of use cases encountered when the transportation network is being designed. By having more coverage, designers may more quickly address suboptimal use cases that have been discovered via the generated travel scenarios. Further, having many generated travel scenarios provides a benchmark to test updates and revisions to the transportation network such that changes do not break existing functionality within the as-designed (or as-deployed) transportation network.

Based on the aforementioned problems, the solution disclosed herein has many benefits. Some benefits include: reduced time to market, increased safety, increased profitability, more robust testing, decreased reliance on human-based designs, identification of issues prior to deployment, increased adoption of hyperloop, increased test coverage, reduction in fossil fuel reliance, increased use of renewable energy, decreased deployment costs, decreased maintenance costs, and more. The benefits shall be manifest as one of skill in the art studies the disclosed solution herein.

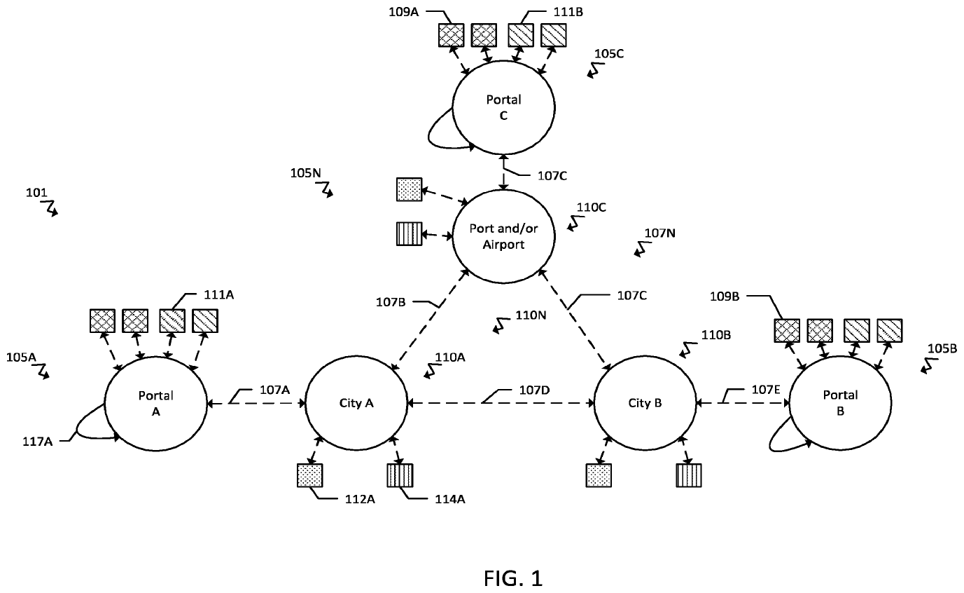

FIG. 1 is a block diagram of a transportation network 101 which represents a logical topology of physical locations utilized to transport cargo and passengers. The transportation network 101 is used throughout the disclosure in order to provide a reference as to how the various elements of the transportation network 101 interact with one another. However, one of skill in the art will appreciate that an actual deployment of a transportation network may be far more complex and require more elements than those depicted.

The transportation network 101 is generally configured to have a plurality of portals 105N comprised of a portal 105A, a portal 105B, and a portal 105C. The portal 105A may have a pick-up point 111A. The pick-up point 111A may be utilized to pick up cargo or passengers with a hyperloop pod. A return loop 117A is generally configured to return hyperloop pods back to another part of the transportation network 101. In one aspect, the return loop 117A may provide a mechanism to route pods within the portal 105A.

The portal 105A is connected to a plurality of hubs 110N comprised of a hub 110A, a hub 110B, and a hub 110C. The plurality of hubs 110N may be interconnected to the plurality of portals 105N as well as to the other hubs within the plurality of hubs 110N. A plurality of routes 107N provide the physical connections between the plurality of hubs 110N and the plurality of portals 105N. In one aspect, the plurality of routes 107N may be near-vacuum tubes operable to house a moving hyperloop pod. The plurality of routes 107N is comprised of a first route 107A, a second route 107B, a third route 107C, a fourth route 107D, and a fifth route 107E.

The portal 105A is connected to the hub 110A via the route 107A. The hub 110A is connected to the hub 110C via the route 107B. The hub 110A is connected to the hub 110B via the route 107D. The hub 110B is connected to the portal 105B via the route 107B. The hub 110C is connected to the portal 105C via the route 107C.

A terminal vehicle may be a truck, an automobile, a ship, an airplane, a train, a trolley, a bus, a ferry, etc. In one aspect, the portal 105C may have limited traversable area such that a terminal vehicle may be unable to quickly reach the cargo held at a pick-up point 111B. For instance, the terminal vehicle may be trapped within a long line of traffic created by the number of terminal vehicles attempting to deliver cargo to the pick-up point 111B. The pick-up point 111B and the drop-off point 109A may be within a port terminal complex that is drivable by a terminal vehicle, walkable by a series of paths, serviced by cranes, etc. In other words, the pick-up point 111B and the drop-off point 109A may be located in difficult-to-reach locations.

For illustration, a typical scenario for drop off of cargo begins at a start point 114A where a hyperloop pod is launched into the hub 110A. The hyperloop pod may travel to the portal 105A to await cargo at the pick-up point 111A. The hyperloop pod may pick up the cargo at the pick-up point 111A and transport the cargo to the portal 105A via a short path. The hyperloop pod carrying the cargo may travel along the route 107A to the hub 110A, which may be a city. Then, the pod may proceed along the route 107B to the hub 110C, which may be an airport or shipping port. Upon arriving at the hub 110C, the pod proceeds to portal 105C via the route 107C. Then, the cargo may be unloaded from the hyperloop pod by tractor or crane to a drop-off point 109A. In one aspect, an airplane may receive the cargo at the drop-off point 109A which may be near a runway. In another aspect, a ship may receive the cargo at the drop-off point 109A by use of a crane or tractor.

In another scenario, passengers arrive at the pick-up point 111B. The passengers may enter a hyperloop pod at the portal 105C and travel via the route 107C to the hub 110C which may be an airport. The passengers in the pod may travel via the route 107C to the hub 110B, which is a city. The hyperloop pod then proceeds along the route 107E to the portal 105B at which point the passengers are unloaded at the drop-off point 109B. In one aspect, the hyperloop pod may proceed along the routes 107D, 107E to a sink point 112A where the pod may be stored, serviced, replaced, etc.

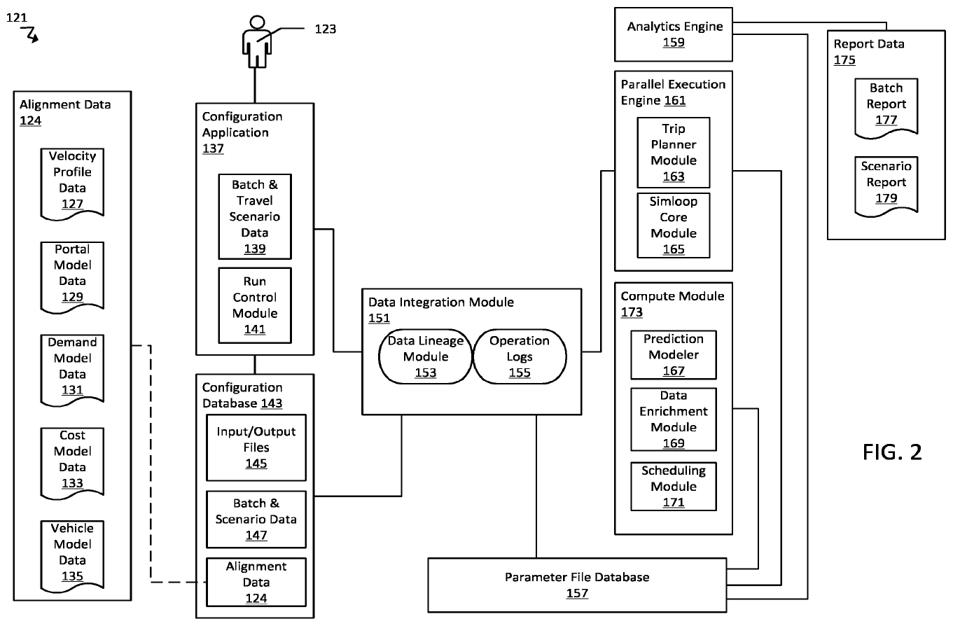

FIG. 2 is a block diagram of a simulation system 121. The simulation system 121 is generally configured to manage a plurality of movements of vehicles that are operating within the transportation network 101. One goal of the simulation system 121 is to plan a sequence of movements to reduce the total number of moves, the lengths of moves, the efficiency of moves, the safety of moves, the cargo/passenger capacity of moves, or a combination thereof. The simulation system 121 may take into consideration time windows related to the transportation of cargo and/or passengers. For example, the simulation system 121 may schedule the departure of a hyperloop pod from the portal 105A to correlate to the arrival of a ship at the portal 105C. Further, the alignment of scheduling between the hyperloop pod and the arriving ship may be synchronized to any tractor equipment required for loading and unloading operations at the portal 105C.

In general, cargo and passengers may have their movement governed by a travel agreement stored within the simulation system 121. The travel agreement generally relates to the duration of travel, the speed of travel, the number of stops, the fare, the flexibility of arrival/departure times, the amount of luggage, the amount of cargo, the discounts associated with a fare, any last-mile transportation, terminal vehicle coordination, etc.

For example, a travel agreement may contain a provision wherein the passenger receives a discounted fare in exchange for travelling at a time of day that is more optimal for the simulation system 121 as related to the management of the entire transportation network 101. Likewise, a fare may be higher if the cargo or passenger must arrive at a particular time and location. Providing such incentives to passengers (or PAX in general) is desirable for hyperloop operators; however, such incentives must be carefully calibrated in order to maintain profitability. The disclosed solution provides such hyperloop operators with the capability to simulate and schedule such discounts in order to increase not just profitability but also passenger comfort. Such simulation may be before, after, and during the operation of the transportation network 101.

With the multiaccess nature of the plurality of portals 105N, the simulation system 121 may have predictive capabilities to generate and execute travel scenarios to meet the demands reflected in travel agreements. Typically, designers and hyperloop operators may evaluate such travel scenarios to determine adherence to said travel agreements such that the transportation network 101 may be validated through simulation. The simulation system 121 may provide feedback to entities responsible for the travel agreement such that the travel agreements may be updated in real-time or at a later date. For example, a travel agreement may require a cargo shipment to arrive by 12:30 p.m. at the portal 105C. However, the simulation system 121 may determine that such a travel agreement is too difficult to meet. As such, the simulation system 121 may provide feedback to hyperloop operators in order to request a more optimized time of day that meets the intent of the travel agreement without adversely affecting the transportation network 101.

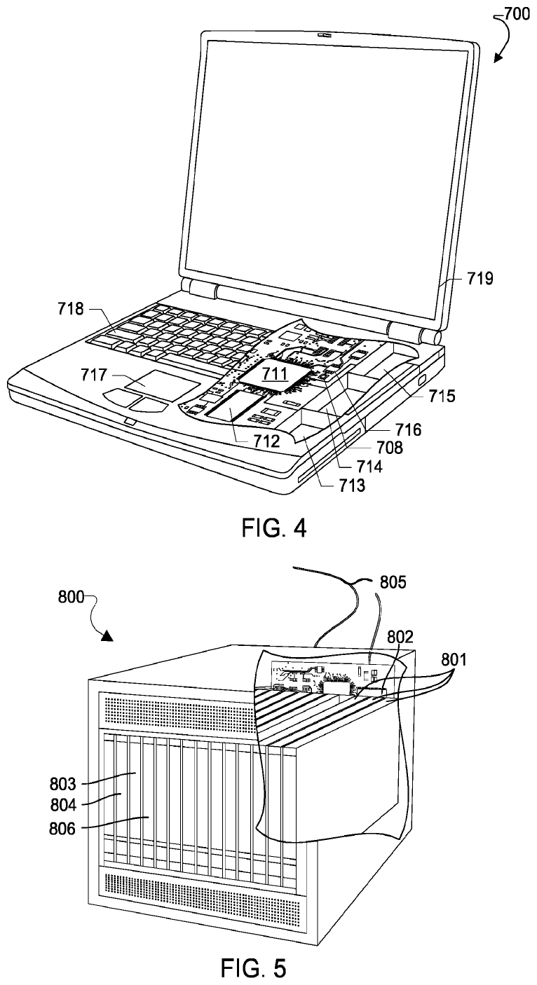

A user 123 may operate a configuration application 137 which may, in one aspect, be a human-usable interface running on a computing device (e.g., as shown in FIG. 4 and FIG. 5 below). The configuration application 137 is generally configured to enable the user 123 to manage the simulation system 121 in order to schedule a simulation. The configuration application 137 has data related to batch and scenario data 139 which contains information related to multiple travel events (e.g., rush hour traffic, weekend holiday demand, cargo delivery during natural disasters, etc.). The configuration application 137 may comprise a run control module 141 that is configured to manage the execution of simulated scenarios.

As stated, the configuration application 137 is generally configured to run on a modern computing device or server (e.g., as shown in FIG. 4 and FIG. 5 below). In one aspect, the configuration application 137 may be a desktop application running on Microsoft® Windows, Apple® MacOS, Unix, etc. In another aspect, the configuration application 137 may be an application running on Android® or iOS®. One of skill in the art will appreciate that the enumerated examples are merely illustrative and not limiting. Further, such application and apps may be interconnected such that the configuration application 137 may run on a desktop system (e.g., Microsoft® Windows) as well as a mobile operating system (e.g., Android®). Still further, the configuration application 137 may be configured to operate in the cloud and be accessible by a modern web browser (e.g., Google® Chrome, Microsoft® Edge, Apple® Safari, etc.).

The configuration application 137 is in communication with a configuration database 143. The configuration database 143 may have input/output files 145 which are stored and retrieved by the configuration application 137. For example, the configuration application 137 may input a file containing scenario data which would then be stored in the input/output files 145. The configuration database 143 may contain batch and scenario data 147 which is merely persistent instances of the batch and scenario data 139 stored in the configuration application 137.

The configuration database 143 generally contains alignment data 124. The alignment data 124 generally contains the constraints related to the simulation system 121, which is generating optimized movement events within the transportation network 101. The alignment data 124 may contain velocity profile data 127 which relates to the speeds at which various vehicles travel (e.g., the hyperloop pods, the terminal vehicles, etc.).

The configuration database 143 may be embodied by a number of various database systems. For example, the configuration database 143 may be an SQL database such as MySQL, MariaDB, SQLite, PostgreSQL, a blockchain, etc. One of skill in the art will appreciate that many types of databases exist in the current state of the art. As such, the details of such an implementation may be left to the designers at the time of deployment.

Portal model data 129 is located within the alignment data 124. In one aspect, the portal model data 129 represents a logical map of the various pick-up and drop-off points within a given portal (e.g., the location of the drop-off point 111B within the portal 105C). Demand model data 131 may be stored as part of the alignment data 124; the demand model data 131 relates to real-world demands of cargo and passengers moving through the transportation network 101.

For example, demand model data 131 may be the number of passengers desiring to travel from the hub 110A to the hub 110B between the hours of 8:00 and 13:00. Further, the amount of passenger luggage may be part of the demand model data 131. Passengers may elect to purchase improved types of cabin seats (e.g., first-class seats). As such, the demand model data 131 may contain information relating to the class of travel for the passengers holding a particular ticket (with a fare).

The alignment data 124 further contains cost model data 133 relating to the monetary costs of a particular trip. For example, the cost model data 133 may be related to a particular demand model data 131 (e.g., the cost of traveling during a holiday weekend may be higher than travel during a typical weekend). Costs may be in any conceivable currency or cryptocurrency. Further, the cost model data 133 may have logic that accounts for inflation over time, changes in currency exchange rates, and other macroeconomic considerations.

Finally, the alignment data 124 contains vehicle model data 135 which generally relates to representing the various vehicles operating within the transportation network 101. In one aspect, the simulation system 121 is configured to manage disparate types of vehicles (e.g., terminal vehicles, hyperloop pods, etc.). At a very high level, one of skill in the art will appreciate that much of the data within the alignment data 124 may be considered constraints on the simulation system 121 within which the simulation system 121 needs to operate. Further, one of skill in the art will appreciate that many more constraints could be imposed on the simulation system 121 (e.g., weather, height limits, speed limits, jurisdictional boundaries, braking distances, communication intervals, emergency monitoring intervals, energy consumption metrics, etc.).

A data integration module 151 is generally in communication with the configuration application 137 and the configuration database 143. The data integration module 151 may contain a data lineage module 153 and operation logs 155. The data lineage module 153 generates and stores simulated run data relating to simulated operations within the simulation system 121 such that events may be fully traced during (or after) simulation. For example, in the event of a simulated pod failure, the data lineage module 153 may contain the necessary data to understand the simulated failure in order to prevent real-world failures. Such an understanding of simulated failures informs designers and hyperloop operators of potential points of failure such that the failures may be corrected prior to occurring in the real-world. In another aspect, the data lineage model 153 may be utilized as part of the prediction module 167 (discussed below).

A parallel execution engine 161 generally hosts a trip planner module 163 which is configured to plan a plurality of movements to physically move cargo or passengers between two points (e.g., the pick-up point 111A and the drop-off point 109A). The trip planner module 163 may consider the alignment data 124 when planning a trip scenario for a particular cargo container or passenger. For example, the trip planner module 163 may determine, based on the demand model 131 and the cost model 133 outputs, that the near-optimal route for a passenger may be along the routes 107D, 107E during normal hours; however, during rush hour, the trip planner module 163 may suggest a plurality of movements using the routes 107B, 107C, 107E in order to avoid traffic congestion as well as increase passenger comfort and maintain fare pricing.

The simloop core 165 is generally configured to perform multiple executions of various batches and travel scenarios (e.g., the batch and travel scenario data 139, 147). The simloop core 165 may be executed via the configuration application 137. For example, the user 123 may create batches and scenarios to simulate a shipment of cargo from the portal 105C to the portal 105B based on a planned downtime of the route 107C that requires the hyperloop pods to be rerouted to the routes 107B, 107D. Further, the simloop core 165 may take into consideration the number of bays within the portal 105B such that the number and throughput of terminal vehicles can be simulated. Such simulations may assist autonomous operation algorithms utilized within the network 101 and the simulation system 121. Further, such simulations inform human designers (e.g., the user 123) as to how an improvement to the transportation network 101 may be made.

In one aspect, the simloop core 165 is operable to execute many batches and scenarios 139, 147 using a Monte Carlo algorithm. The simloop core 165 may then prove the robustness of the simulation system 121 as related to the transportation network 101 operating under various circumstances, including and beyond a current implementation. One goal of such testing is to determine (1) each possible failure and (2) the likelihood that such a failure may affect the transportation network 101.

The simloop core 165 is configured to generate predictions based on historical simulation run results. In one aspect, the historical simulated run results may be retrieved from the data lineage module 153. Predictions generally relate to events that may occur within the transportation network 101. Examples of events include inclement weather, power outages, maintenance scheduling, traffic congestion, increased user demand, increased cargo demand, downtime of pods, fire, smoke, loss of cabin pressure, increase in tube pressure, excessive wait time, cancelled fares, etc. One of skill in the art will appreciate that one advantage of the disclosed solution is the capability to predict events that were not thought possible by designers and hyperloop operators, thus enhancing both the design and operation of the transportation network 101.

The parallel execution engine 161 may be in communication with a parameter file database 157. In one aspect, the parameter file database 157 hosts data utilized by a compute module 173 which utilizes any data stored in the parameter file database 157. In one aspect, the compute module 173 may be scalable and hosted within a cloud operating environment (e.g., Microsoft® Azure, Google® Cloud, Amazon® AWS, etc.). One of skill in the art will appreciate that the computer module 173 may be operable to process “big data.” The compute module 173 contains a prediction modeler 167. The prediction modeler 167 may be utilized in conjunction with the trip planner module 163 or the simloop core 165.

The compute module 173 hosts a data enrichment module 169. The data enrichment module 169 is generally configured to perform enhancements to collected raw data. Further, the data enrichment module 169 may include more relevant context such that the raw data is more discriminative for the prediction modeler 167.

The compute module 173 contains a scheduling module 171 which may perform scheduling operations for the trip planner module 163 and the simloop core module 165. For example, the scheduling module 171 may be utilized to simulate trips based on location and times such that various trips may be coordinated with respect to both time and space. In one aspect, the scheduling module 171 may perform logistical analysis to increase cargo or passenger throughput and reduce the resources required (e.g., number of hyperloop pods in operation, electricity consumption, human workers servicing the transportation network 101, etc.).

An analytics engine 159 is generally configured to perform analysis on the events occurring throughout the entire simulation system 121. For example, stakeholders (e.g., hyperloop operators, designers, etc.) of the transportation network 101 may review report data 175 to understand any number of aspects of the transportation network 101 as simulated or in operation. In one aspect, the stakeholders may review a batch report 177 which contains a number of travel scenarios described in detail (e.g., time, cargo weight, terminal vehicle type, arrival portal, destination portal, peak velocity, etc.). In another aspect, the stakeholders may review a travel scenario report 179 which correlates a number of events related to a particular batch or travel scenario. One of skill in the art will appreciate that the user 123 may be such a stakeholder reviewing events within the simulation system 121 via the configuration application 137 (e.g., as operating on a Mac computer).

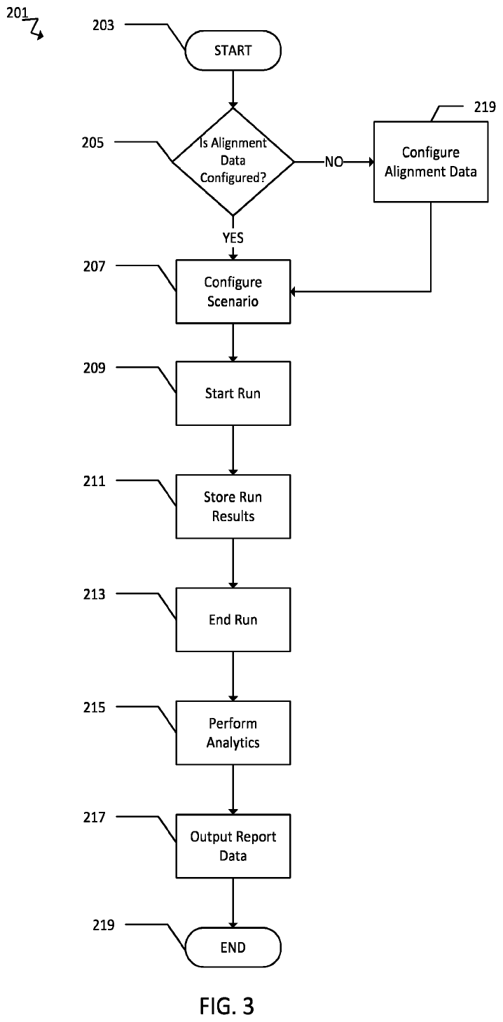

FIG. 3 is a flow diagram illustrating a process 201 for simulating the transportation network 101. The process 201 begins at the start block 203 and proceeds to the decision block 205. At the decision block 205, the process 201 determines whether the alignment data 124 has been configured in the simulation system 121. For example, the process 201 may retrieve alignment data 124 from the configuration database 143. If the alignment data 124 has not been set, the process 201 proceeds to the block 219 where the process 201 configures the alignment data 124. The alignment data 124 may be prepopulated with default data, in one aspect. For instance, default values of the cost model data 133 may be used as a starting point for the user 123 configuring the simulation system 121. The configured alignment data 124 may be stored in the configuration database 143 such that designers and hyperloop operators may later retrieve configuration-related data.

Returning to the decision block 205, the process 201 may determine that the alignment data 124 has been configured and proceed along the YES branch to the block 207. At the block 207, the process 201 configures a travel scenario. An example of a travel scenario may be a holiday weekend on which many passengers travel to sporting events located in the hubs 110A, 110B. In one aspect, the batch and travel scenario data 139, 147 may be retrieved from the configuration database 143. In another aspect, the batch and travel scenario data 139, 147 may be loaded into the configuration application 137 such that the user 123 may interact with the parameters of the travel scenario (e.g., the number of passengers, the number of available hyperloop pods, congestion at portals, maintenance schedules, etc.). Once the travel scenario has been configured, the process 201 proceeds to the block 209.

At the block 209, the process 201 starts a run of the simulation. The process 201 may utilize the parallel execution module 161 to execute instructions within the simloop core module 165 such that the simulated results may be calculated using parallel processing. In one aspect, the simloop core module 165 is executed in parallel such that the number of simulations per interval may be increased; the benefit of such increase in processing is to better support designers and hyperloop operators that are seeking to reduce time to market. The results of the simulated run are stored in simulated run results. The process 201 then proceeds to the block 211.

At the block 211, the process 201 stores the simulated run results in the data integration module 151. In one aspect, the process 201 may store the simulated run results in the data lineage model 153, thus providing a historical set of simulations. Designers and hyperloop operators may trace through the historical simulated run results in order to identify areas of optimization for the transportation network 101 being simulated.

The process 201 may begin logging data for storage within the operation logs 155. For example, simulation system 121 may log the expected arrival times of hyperloop pods compared to actual arrival times of said hyperloop pods. In one aspect, the operational logs 155 provide designers and hyperloop operators with a source of raw data for advanced diagnostic and debugging purposes. The process 201 then proceeds to the block 213.

At the block 213, the process 201 ends the simulation run. Any pending results are then written to a database (e.g., the parameter file database 157). The process 201 then proceeds to the block 215.

At the block 215, the process 201 performs analytics on the simulation run results gathered at the block 211. In one aspect, the process 201 utilizes the analytics engine 159 to highlight more actionable data for stakeholders (e.g., hyperloop operators, designers, etc.) to evaluate the performance of the transportation network 101. For example, the analytics engine 159 may determine the number of return passengers based on previous trips taken by the same passenger. Further, the analytics engine 159 may infer that a previous trip of a passenger (or PAX in general) may have been to visit a particular location (e.g., a concert, a sporting event, etc.). The process 201 then proceeds to the block 217.

At the block 217, the process 201 instructs the simulation system 121 to output a report. In one aspect, the output may be based on the report data 175. For instance, the travel scenario report 179 may contain details about the inputs and outputs of a particular travel scenario (or batch of scenarios) such that stakeholders may adjust the transportation network 101 to optimize a particular feature or outcome. For example, some hyperloop operators of the transportation network 101 may value having more passengers paying lower fares while another hyperloop operator may desire fewer passengers paying higher fares. One of skill in the art will appreciate that the business needs of hyperloop operators vary wildly; however, the disclosed solution provides a system and method for said hyperloop operators to meet disparate and sometimes conflicting aims. The process 201 then proceeds to the end block 219 and terminates.

FIG. 4 is a block diagram illustrating an example computing device 700 suitable for use with the various aspects described herein. The process 201 may be executed on the computing device 700. The simulation system 121 may be executed on the computing device 700.

In one aspect, the computing device 700 may be operable to store and execute the simulation system 121. The computing device 700 may include a processor 711 (e.g., an ARM processor) coupled to volatile memory 712 (e.g., DRAM) and a large capacity nonvolatile memory 713 (e.g., a flash device). Additionally, the computing device 700 may have one or more antenna 708 for sending and receiving electromagnetic radiation that may be connected to a wireless data link and/or cellular telephone transceiver 716 coupled to the processor 711. The computing device 700 may also include an optical drive 714 and/or a removable disk drive 715 (e.g., removable flash memory) coupled to the processor 711. The computing device 700 may include a touchpad touch surface 717 that serves as the computing device's 700 pointing device, and thus may receive drag, scroll, flick etc. gestures similar to those implemented on computing devices equipped with a touch screen display as described above. In one aspect, the touch surface 717 may be integrated into one of the computing device's 700 components (e.g., the display). In one aspect, the computing device 700 may include a keyboard 718 which is operable to accept user input via one or more keys within the keyboard 718. In one configuration, the computing device's 700 housing includes the touchpad 717, the keyboard 718, and the display 719 all coupled to the processor 711. Other configurations of the computing device 700 may include a computer mouse coupled to the processor (e.g., via a USB input) as are well known, which may also be used in conjunction with the various aspects described herein.

FIG. 5 is a block diagram illustrating an example server 800 suitable for use with the various aspects described herein. The server 800 may be operable to store and execute the simulation system 121. The server 800 may be operable to execute the process 201.

The server 800 may include one or more processor assemblies 801 (e.g., an x86 processor) coupled to volatile memory 802 (e.g., DRAM) and a large capacity nonvolatile memory 804 (e.g., a magnetic disk drive, a flash disk drive, etc.). As illustrated in instant figure, processor assemblies 801 may be added to the server 800 by inserting them into the racks of the assembly. The server 800 may also include an optical drive 806 coupled to the processor 801. The server 800 may also include a network access interface 803 (e.g., an ethernet card, WIFI card, etc.) coupled to the processor assemblies 801 for establishing network interface connections with a network 805. The network 805 may be a local area network, the Internet, the public switched telephone network, and/or a cellular data network (e.g., LTE, 5G, etc.).

The foregoing method descriptions and diagrams/figures are provided merely as illustrative examples and are not intended to require or imply that the operations of various aspects must be performed in the order presented. As will be appreciated by one of skill in the art, the order of operations in the aspects described herein may be performed in any order. Words such as “thereafter,” “then,” “next,” etc. are not intended to limit the order of the operations; such words are used to guide the reader through the description of the methods and systems described herein. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects described herein may be implemented as electronic hardware, computer software, or combinations of both. To clearly illustrate this interchangeability of hardware and software, various illustrative components, blocks, modules, circuits, operations, etc. have been described herein generally in terms of their functionality. Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc. described in connection with the aspects described herein may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described herein. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed herein may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk storage, magnetic storage smart objects, or any other medium that may be used to store program code in the form of instructions or data structures and that may be accessed by a computer. Disk as used herein may refer to magnetic or non-magnetic storage operable to store instructions or code. Disc refers to any optical disc operable to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the aspects illustrated herein but is to be accorded the widest scope consistent with the claims disclosed herein.

1. A method for simulating a transportation network, the method comprising:
configuring, at a configuration application running on a processor, alignment data, the alignment data relating to real-world constraints of the transportation network;
storing, at a configuration database running on the processor, the alignment data;
defining, at the configuration application running on the processor, a plurality of travel scenarios, the plurality of travel scenarios relating to movement of vehicles in the transportation network;
storing, at the configuration database, the plurality of travel scenarios;
simulating, at the data integration module running on the processor, a simulated run of a plurality of vehicles, the simulating being performed based on the plurality of travel scenarios and the alignment data;
storing, at a data integration module running on the processor, a plurality of simulated run results;
generating, at an analytics engine running on the processor, a plurality of analytics, the plurality of analytics being based on the plurality of simulated run results; and
outputting, at the configuration application, report data, the report data comprising the plurality of simulated run results and the plurality of analytics.

2. The method of claim 1, wherein the plurality of vehicles is selected from the group consisting of: a hyperloop pod and a terminal vehicle.

3. The method of claim 1, wherein the alignment data further comprises velocity profile data, portal model data, demand model data, cost model data, and vehicle model data.

4. The method of claim 1, wherein the simulated run is executed on the processor, the executing being performed in parallel.

5. The method of claim 1, the method further comprising:
predicting, at a prediction modeler running on the processor, an event occurring within the transportation network, the predicting being performed based on the plurality of simulated run results.

6. The method of claim 1, wherein the configuration application is a desktop application, a mobile application, a cloud-based application, or a combination thereof.

7. The method of claim 1, wherein the simulated run is performed on a batch of travel scenarios selected from the plurality of travel scenarios.

8. The method of claim 7, wherein the batch of travel scenarios is generated using a Monte Carlo algorithm.

9. The method of claim 7, wherein the report data further comprises a batch report, the batch report being based on the batch of travel scenarios.

10. A server configured to simulate a transportation network, the server comprising:
a memory, the memory storing a configuration database, a configuration application, an analytics engine, a prediction modeler, and a data integration module;
a processor, the processor configured to:
configure, at the configuration application, alignment data, the alignment data relating to real-world constraints of the transportation network;
store, at the configuration database, the alignment data;
define, at the configuration application, a plurality of travel scenarios, the plurality of travel scenarios relating to movement of vehicles in the transportation network;
store, at the configuration database, the plurality of travel scenarios;
simulate, at a data integration module, a simulated run of a plurality of vehicles, the simulating being performed based on the plurality of travel scenarios and the alignment data;
store, at a data integration module, a plurality of simulated run results;
generate, at the analytics engine, a plurality of analytics, the plurality of analytics being based on the plurality of simulated run results; and
output, at the configuration application, report data, the report data comprising the plurality of simulated run results and the plurality of analytics.

11. The server of claim 10, wherein the plurality of vehicles is selected from the group consisting of: a hyperloop pod and a terminal vehicle.

12. The server of claim 10, wherein the alignment data further comprises velocity profile data, portal model data, demand model data, cost model data, and vehicle model data.

13. The server of claim 10, wherein the simulated run is executed using parallel processing.

14. The server of claim 10, the processor being further configured to:
predict, at the prediction modeler, an event occurring within the transportation network, the predicting being performed based on the plurality of simulated run results.

15. The server of claim 10, wherein the configuration application is a desktop application, a mobile application, a cloud-based application, or a combination thereof.

16. The server of claim 10, wherein the simulated run is performed on a batch of travel scenarios selected from the plurality of travel scenarios.

17. The server of claim 16, wherein the batch of travel scenarios is generated using a Monte Carlo algorithm.

18. The server of claim 16, wherein the report data further comprises a batch report, the batch report being based on the batch of travel scenarios.

19. A computer-readable medium storing instructions that, when executed by a computer, cause the computer to:
configure, at a configuration application running on a processor, alignment data, the alignment data relating to real-world constraints of the transportation network;
store, at a configuration database running on the processor, the alignment data;
define, at the configuration application running on the processor, a plurality of travel scenarios, the plurality of travel scenarios relating to movement of vehicles in the transportation network;
store, at the configuration database running on the processor, the plurality of travel scenarios;
simulate, at a data integration module running on the processor, a simulated run of a plurality of vehicles, the simulating being performed based on the plurality of travel scenarios and the alignment data;
store, at the data integration module running on the processor, a plurality of simulated run results;
generate, at an analytics engine running on the processor, a plurality of analytics, the plurality of analytics being based on the plurality of simulated run results; and
output, at the configuration application, report data, the report data comprising the plurality of simulated run results and the plurality of analytics.

20. The computer-readable medium of claim 19, the instructions further comprising:
predict, at a prediction modeler running on the processor, an event occurring within the transportation network, the predicting being performed based on the plurality of simulated run results.
